(19) United States
(12) Patent Application Publication
(10) Pub. No.: US 2025/0284403 A1
(43) Pub. Date: Sep. 11, 2025

(54) SEQUENTIAL AND RANDOM READ OPERATIONS IN MEMORY SYSTEMS

(71) Applicant: Micron Technology, Inc., Boise, ID (US)

(72) Inventors: Feng Xu, Shanghai (CN); Wenjun Wu, Shanghai (CN); Xiongjian Wu, Shanghai (CN)

(21) Appl. No.: 19/065,258

(22) Filed: Feb. 27, 2025

Related U.S. Application Data
(60) Provisional application No. 63/561,638, filed on Mar. 5, 2024.

(51) Int. Cl. G06F 3/06

(52) U.S. Cl. CPC G06F 3/0613; G06F 3/0659; G06F 3/0679

(57) ABSTRACT

Methods, systems, and devices for sequential and random read operations in memory systems are described. A memory system may generate memory system commands based on whether a read command from a host system is associated with a sequential address or non-sequential address. The memory system may include a counter that increments based on receiving a sequential read command and may output different command types based on a value of the counter. Additionally, or alternatively, a memory system may adjust a size of a data transfer unit based on a size of a generated command as well as a remaining size of the data transfer unit. The memory system may combine data associated with multiple read commands into a single data transfer unit based on the size of the generated read command satisfying a threshold and the remaining size of the data transfer unit satisfying a threshold.

### CROSS REFERENCE

The present application for patent claims priority to U.S. Patent Application No. 63/561,638 by Xu et al., entitled “SEQUENTIAL AND RANDOM READ OPERATIONS IN MEMORY SYSTEMS,” filed Mar. 5, 2024, which is assigned to the assignee hereof, and which is expressly incorporated by reference in its entirety herein.

### TECHNICAL FIELD

The following relates to one or more systems for memory, including sequential and random read operations in memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIGS. 1 and 2 show examples of systems that support sequential and random read operations in memory systems in accordance with examples as disclosed herein.

FIGS. 3 and 4 show examples of processes that support sequential and random read operations in memory systems in accordance with examples as disclosed herein.

FIG. 5 shows an example of a process flow that supports sequential and random read operations in memory systems in accordance with examples as disclosed herein.

FIG. 6 shows a block diagram of a memory system that supports sequential and random read operations in memory systems in accordance with examples as disclosed herein.

FIGS. 7 and 8 show flowcharts illustrating a method or methods that support sequential and random read operations in memory systems in accordance with examples as disclosed herein.

### DETAILED DESCRIPTION

A memory system may store sequentially-written data, or randomly-written data (e.g., non-sequentially written data), or a combination thereof to one or more memory devices of the memory system (e.g., to one or more pages of memory cells, to one or more planes of memory cells). Storage locations of the memory system may be considered “dirty” based on including a relatively high proportion of randomly-written data. For instance, dirty data may be associated with a relatively large ratio of randomly-written data to sequentially-written data (e.g., a relatively large degree of randomness), which may adversely affect a performance of read operations (e.g., sequential read operations, may reduce processing speeds). A memory system may receive one or more read commands from a host system (e.g., host read commands, sequential read commands), and may be configured to implement (e.g., generate, output, issue) multiple types of commands (e.g., firmware commands, independent word line (IWL) snap read commands, multi-plane snap read commands, back-end commands) to retrieve data from one or more memory devices of the memory system corresponding to (e.g., in response to) the one or more read commands from the host system. However, the memory system may not consider a ratio of random-to-sequential data to determine (e.g., select, identify) which type of command to output.

In accordance with one or more techniques described herein, a memory system may support a dynamic (e.g., responsive, situational) determination of memory system commands (e.g., types of memory system commands) based on a ratio of random-to-sequential data (e.g., based on a degree of randomness, based on a degree of dirtiness) targeted by one or more commands from a host system. For example, the memory system may output, to one or more memory devices, a first type of command (e.g., an IWL read command, a single-plane read command) or a second type of command (e.g., a non-IWL command, a multi-plane read command) based on whether a set of read commands received from the host system are associated with sequential addresses. In some examples, the memory system may include a tracker, such as a counter, that increments based on receiving a sequential read command and may issue different command types based on whether a value of the tracker, such as the counter, satisfies a threshold or fails to satisfy a threshold. Additionally, or alternatively, a memory system may support dynamic adjustments to data transfer units (e.g., units used to transfer data from the memory system to a host system) based on a size of a generated command (e.g., a memory system generated command) as well as a remaining size of a data transfer unit. For example, a memory system may combine data associated with multiple read commands into a single data transfer unit based on the size of the generated read command satisfying a threshold and the remaining size of the data transfer unit satisfying a threshold. Thus, the memory system may be configured to support relatively higher data throughput (e.g., associated with dirty sequential reads) and provide increased performance (e.g., increased input/output operations per second (IOPS)).

In addition to applicability in memory systems as described herein, techniques for sequential and random read operations in a memory may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing idle durations of a memory device and improving throughput of random (e.g., dirty) sequential read commands, which may decrease processing or latency times, improve response times, and otherwise improve user experience.

Features of the disclosure are illustrated and described in the context of systems, devices, and circuits. Features of the disclosure are further illustrated and described in the context of processes, block diagrams, and flowcharts.

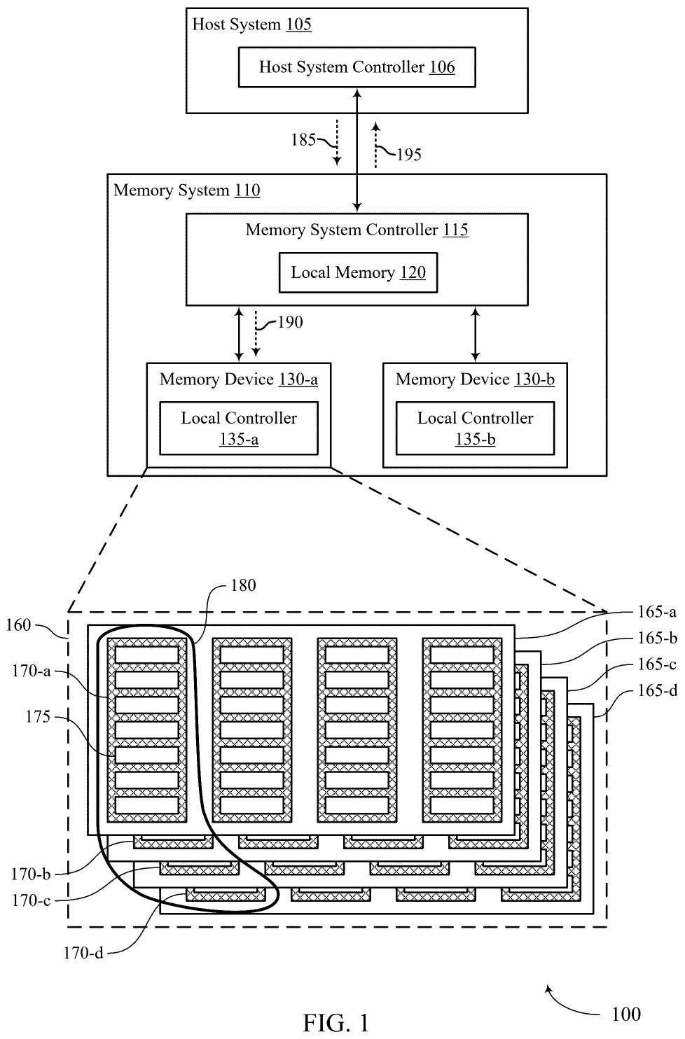

FIG. 1 shows an example of a system 100 that supports sequential and random read operations in memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some cases, a memory system 110 may store sequentially-written data, randomly-written data, or a combination thereof to one or more memory devices 130 of the memory system 110 (e.g., to one or more pages 175, to one or more planes 165). For instance, one or more memory devices 130 may store dirty data (e.g., a relatively high proportion of randomly-written data as compared to sequentially-written data), and accessing dirty data (e.g., based on one or more read commands 185 from a host system 105) may adversely affect a performance of read operations. In some cases, a memory system 110 may not account for a degree of data randomness (e.g., dirtiness) while executing a host command (e.g., for sending commands 190 to one or more memory devices 130), which may be relatively inefficient for relatively high degrees of random data (e.g., based on idle planes 165 while executing a multi-plane read command for randomly stored data). Moreover, the memory system 110 may not account for a size of commands (e.g., read commands 185 from the host system 105, read commands 190 generated by the memory system 110 and transmitted to one or more memory devices 130) while retrieving the data from a memory device 130, which may result in reduced throughput associated with a data transfer to the host system 105.

As described herein, a memory system 110 may (e.g., via firmware instructions executed by a memory system controller 115) generate a type of command 190 (e.g., a read command from a memory system controller 115, a read command to a memory device 130, a memory system command, a NAND read command, a back-end command, a B-command (BCMD)) based on a degree of data dirtiness associated with one or more read commands 185 (e.g., a read command to a memory system 110, a host command, a front-end command) from a host system 105. For example, the memory system 110 may generate (e.g., and output to one or more memory devices 130) a first type of command 190 (e.g., a command associated with accessing a single plane 165 of a memory device 130, an IWL read command) or a second type of command 190 (e.g., a command associated with accessing multiple planes 165 of a memory device 130, a non-IWL command) based on whether a set of host read commands 185 are associated with sequential addresses (e.g., a set of continuous physical page addresses (PPAs) of a memory device 130). In some examples, the memory system 110 (e.g., a memory system controller 115) may output (e.g., to a memory device 130) a command 190 based on whether a quantity of sequential addresses (e.g., monitored via a counter or other tracker) satisfies a threshold. In some examples, the memory system 110 (e.g., the memory system controller 115) may, additionally, or alternatively, adjust a size of a data transfer unit 195 (e.g., a unit of data transferred from a memory system 110 to a host system 105) based on a size of a generated command 190 (e.g., a command generated at the memory system 110, a command from a memory system controller 115 to a memory device 130) as well as a remaining size of a data transfer unit 195. Thus, the memory system 110 may be configured to support relatively higher data throughput (e.g., for sequential read commands 185 associated with accessing dirty storage locations of the memory system 110) and improved performance metrics (e.g., IOPS), among other benefits.

The system 100 may include any quantity of non-transitory computer readable media that support sequential and random read operations in memory systems. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

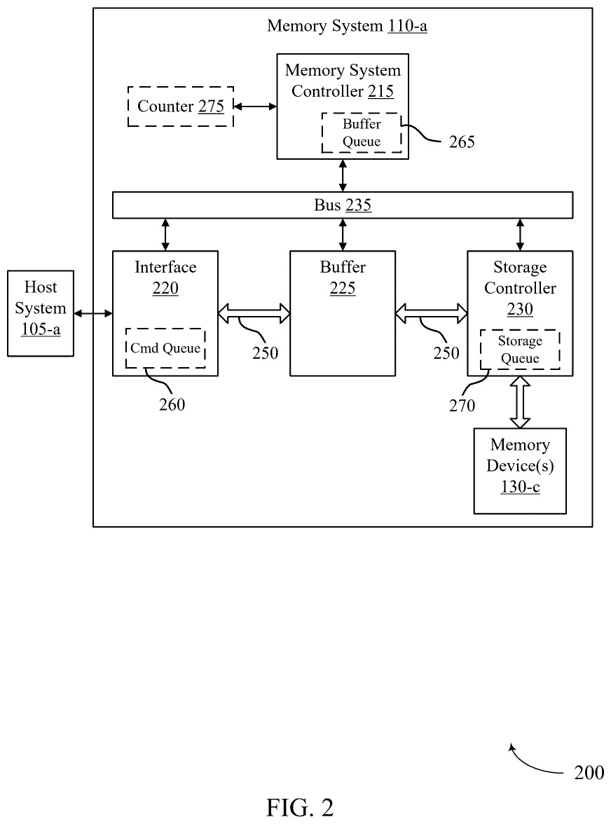

FIG. 2 shows an example of a system 200 that supports sequential and random read operations in memory systems in accordance with examples as disclosed herein. The system 200 may include a memory system 110-a configured to store data received from the host system 105-a and to send data to the host system 105-a, if requested by the host system 105-a using access commands (e.g., read commands 185, write commands). The system 200 may implement aspects of the system 100 as described with reference to FIG. 1. For example, the memory system 110-a and the host system 105-a may be examples of the memory system 110 and the host system 105, respectively.

The memory system 110-a may include one or more memory devices 130-c to store data transferred between the memory system 110-a and the host system 105-a (e.g., in response to receiving access commands from the host system 105-a). The memory devices 130-c may include one or more memory devices as described with reference to FIG. 1. For example, the memory devices 130-c may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 110-a may include a storage controller 230 for controlling the passing of data directly to and from the memory devices 130-c (e.g., for storing data, for retrieving data, for determining memory locations in which to store data and from which to retrieve data). The storage controller 230 may communicate with memory devices 130-c directly or via a bus (not shown), which may include using a protocol specific to each type of memory device 130-c. In some cases, a single storage controller 230 may be used to control multiple memory devices 130-c of the same or different types. In some cases, the memory system 110-a may include multiple storage controllers 230 (e.g., a different storage controller 230 for each type of memory device 130-c). In some examples, one or more storage controllers 230 may be included in a memory system controller 215 or otherwise included in a memory system controller 115. In some cases, a storage controller 230 may implement aspects of a local controller 135 as described with reference to FIG. 1.

The memory system 110-a may include an interface 220 for communication with the host system 105-a, and a buffer 225 for temporary storage of data being transferred between the host system 105-a and the memory devices 130-c. The interface 220, buffer 225, and storage controller 230 may support translating data between the host system 105-a and the memory devices 130-c (e.g., as shown by a data path 250), and may be collectively referred to as data path components. In some examples, aspects of an interface 220 and a buffer 225 may also be included in a memory system controller 215 or otherwise included in a memory system controller 215.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 105-a. In some examples, read commands may be added to a queue without an operation to match the address to addresses already in the buffer 225 (e.g., without a cache address match or lookup operation).

The memory system 110-a also may include a memory system controller 215 for executing the commands received from the host system 105-a, which may include controlling the data path components for the moving of the data. The memory system controller 215 may be an example of or may be included in a memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 105-a is processed concurrently by the memory system 110-a. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 110-a.

Data transferred between the host system 105-a and the memory devices 130-c may be conveyed along a different path in the memory system 110-a than non-data information (e.g., commands, status information). For example, the system components in the memory system 110-a may communicate with each other using a bus 235, while the data may use the data path 250 through the data path components instead of the bus 235. The memory system controller 215 may control how and if data is transferred between the host system 105-a and the memory devices 130-c by communicating with the data path components over the bus 235 (e.g., using a protocol specific to the memory system 110-a).

If a host system 105-a transmits access commands to the memory system 110-a, the commands may be received by the interface 220 (e.g., according to a protocol, such as a UFS protocol or an eMMC protocol). Thus, the interface 220 may be considered a front end of the memory system 110-a. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 130-c and transmitting the data to the host system 105-a. For a write command, this may include receiving data from the host system 105-a and moving the data to one or more memory devices 130-c. In either case, the memory system controller 215 may use the buffer 225 for, among other things, temporary storage of the data being received from or sent to the host system 105-a. The buffer 225 may be considered a middle end of the memory system 110-a. In some cases, buffer address management (e.g., pointers to address locations in the buffer 225) may be performed by hardware (e.g., dedicated circuits) in the interface 220, buffer 225, or storage controller 230.

To process a write command received from the host system 105-a, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 105-a and at least portions of the access commands may be processed concurrently.

If the buffer 225 has sufficient space to store the write data, the memory system controller 215 may cause the interface 220 to transmit an indication of availability to the host system 105-a (e.g., a “ready to transfer” indication), which may be performed in accordance with a protocol (e.g., a UFS protocol, an eMMC protocol). As the interface 220 receives the data associated with the write command from the host system 105-a, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 130-c, which may involve operations of the storage controller 230. For example, the memory system controller 215 may cause the storage controller 230 to retrieve the data from the buffer 225 using the data path 250 and transfer the data to a memory device 130-c. The storage controller 230 may be considered a back end of the memory system 110-a. The storage controller 230 may indicate to the memory system controller 215 (e.g., via the bus 235) that the data transfer to one or more memory devices 130-c has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 130-c associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 130-c to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 105-a, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 130-c and store the data in the buffer 225 for temporary storage using the data path 250. The storage controller 230 may indicate to the memory system controller 215 (e.g., via the bus 235) when (e.g., if) the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 130-c from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 105-a. For example, the memory system controller 215 may cause the interface 220 to retrieve the data from the buffer 225 using the data path 250 and transmit the data to the host system 105-a (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 105-a has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 130-c. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105-a and physical addresses (e.g., physical block addresses) associated with memory cells within the memory devices 130-c. For example, the host system 105-a may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In accordance with examples described herein, a memory system 110-a (e.g., a memory system controller 215, a storage controller 230) may generate different types of commands 190 (e.g., IWL snap read command, multi-plane snap read command) for one or more memory devices 130-c based on a ratio of random-to-sequential data (e.g., a degree of dirty data) associated with one or more received read commands 185 (e.g., from a host system 105-a). The memory system 110-a may determine whether a set of received read commands 185 (e.g., a set of commands 185 included in a command queue 260 or a buffer queue 265) are associated with sequential addresses (e.g., continuous PPAs). For example, the memory system 110-a may include a counter 275 (e.g., a tracker, of or coupled with a memory system controller 215, of a memory system controller 115) that monitors (e.g., counts, tracks) a quantity of sequential addresses. For each received read command 185, the counter 275 may increment if a received command 185 is associated with an first address (e.g., a first PPA) that is sequential to a second address (e.g., a second PPA) of a previously-received command 185 (e.g., sequential to an address of a command 185 stored in the command queue 260 or buffer queue 265, and the counter 275 may reset otherwise. Subsequently, the memory system controller 215 may output (e.g., to a storage controller 230) different types of access commands 190 (e.g., single-plane read commands, multi-plane read commands) based on whether a value of the counter 275 satisfies a threshold value (e.g., a threshold quantity of sequential addresses, is greater than the threshold value, is greater than or equal to the threshold value). Additionally, or alternatively, the memory system 110-a may adjust a size of a data transfer unit 195 (e.g., a buffer, a DATA IN module, a data unit included in a buffer 225) based on a size (e.g., a size in terms of a quantity of bits) of a generated command 190 as well as a remaining size of the data transfer unit 195. For example, the memory system 110-a may be configured to dynamically configure a size of one or more data transfer units 195 (e.g., of a buffer 225) prior to transferring the one or more data transfer units 195 to the host system 105-a (e.g., via a data path 250 and an interface 220). Thus, the memory system 110-a may be configured to support relatively more efficient read command processing techniques resulting in improved performance and user experience.

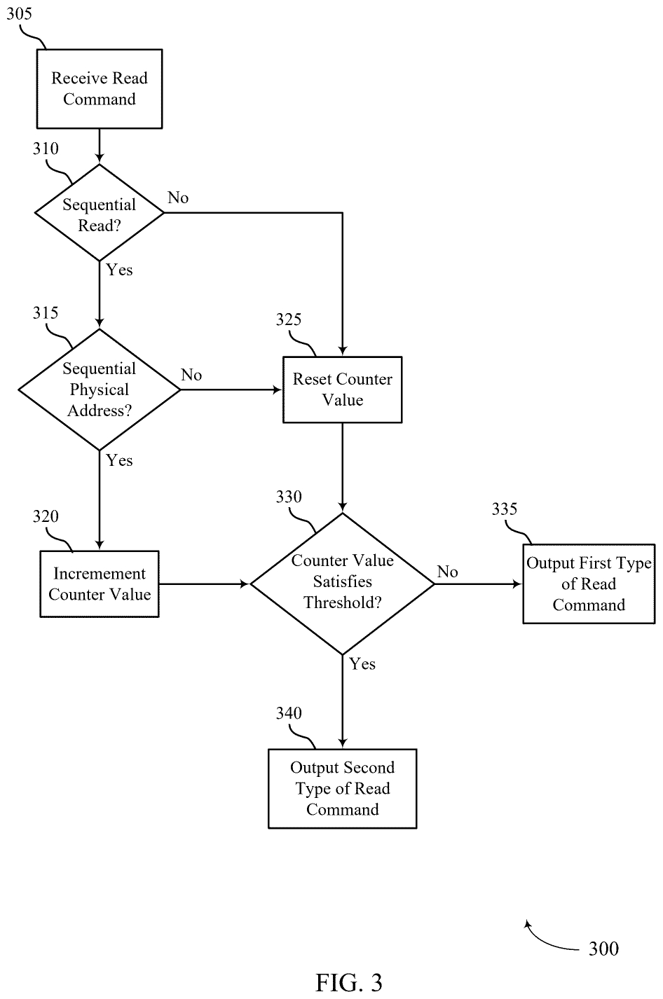

FIG. 3 shows an example of a process 300 that supports sequential and random read operations in memory systems in accordance with examples as disclosed herein. The process 300 may be implemented by aspects of a system 100 or a system 200. For example, a memory system 110 (e.g., a memory system controller 115) may utilize one or more aspects of the process 300 to dynamically (e.g., selectively) output a first type of read command 190 (e.g., a single-plane read command, an IWL snap read command) or a second type of read command 190 (e.g., a multi-plane read command, a non-IWL snap read command) to a memory device 130 based on a sequential characteristic of one or more received read commands 185 (e.g., received from a host system 105). Although the following description of the process 300 illustrates an example flow of operations, the operations may be performed in a different order. Additionally, or alternatively, other operations may be added to or removed from the process 300. For example, some operations may be omitted from the process 300, or may be performed in different orders or at different times.

A memory system 110 may receive one or more read commands 185 from a host system 105. Such read commands may include a set of sequential read commands (e.g., associated with accessing sequential logical addresses, associated with accessing sequential physical addresses), random read commands (e.g., associated with accessing non-sequential logical addresses), or both. In some cases, data may be stored in a storage location of the memory system 110 (e.g., a page 175, a block 170, of one or more memory devices 130) that may store a combination of sequentially-written data and non-sequentially written data (e.g., a dirty storage location). In some cases, a quantity of randomly-written data may be proportional to a degree of dirtiness (e.g., a degree of randomness) associated with the storage location. That is, a degree of dirtiness may be (e.g., measure, indicate) a proportion of randomly-written data (e.g., with a 4 kilobyte (KB) data chunk size) to sequentially-written data of a total data volume. In some cases, an LBA range of the random write may be a same range as the sequential write.

A memory system 110 may be configured to generate multiple types of commands (e.g., internal read commands, commands issued from a memory system controller 115 to a memory device 130, read commands 190) in response to read commands 185 from a host system. For instance, in some cases, a memory system 110 may generate a first type of read command 190 (e.g., a single-plane read command, an IWL snap read command) associated with accessing a single plane 165. In some other cases, the memory system 110 may generate a second type of read command 190 (e.g., a multi-plane read command, a non-IWL snap read command, a multi-plane snap read command, a multi-cache read command) associated with accessing of multiple planes 165. In some cases, a memory system 110 may output a single-plane read command or a multi-plane read command based whether on a size of a set of host read commands (e.g., a set of read commands 185, a “chunk” size) satisfies a threshold. For example, if a quantity of host read commands fails to satisfy (e.g., is less than or equal to) a threshold, the memory system 110 may use a single-plane read command to read (e.g., retrieve) the data. If the quantity of host read commands satisfies (e.g., is greater than or equal to) the threshold, the memory system 110 may use a multi-plane read command (e.g., which may group the one or more read commands) to read the data.

Single-plane read commands and multi-plane snap read commands may be associated with respective benefits and efficiency utilization of such commands may be based on various factors (e.g., workload volume, workload type). For instance, single-plane read commands may improve performance of read commands associated with accessing a relatively high volume of randomly-written data. However, a memory system may not consider a ratio of random-to-sequential data to determine which type of command to use to read data from a memory device 130. For instance, some memory systems may output a multi-plane read command regardless of a degree of dirtiness of data associated with one or more received read commands, which may be relatively inefficient (e.g., may decrease throughput and performance) for relatively high degrees of dirtiness. Thus, as described herein, a memory system 110 may be configured to perform techniques in accordance with process 300 to improve read command processing.

At 305, the memory system 110 may receive a read command 185 (e.g., from a host system 105, a front-end command). In some examples, the memory system 110 may receive the read command 185 as part of a sequence of read commands 185. For example, the read command of 305 may be received after one or more other read commands 185.

At 310, the memory system 110 may determine whether the read command 185 of 305 is indicated to be a sequential read command or a random read command (e.g., via an indication received from a host system 105, using an indication of the command 185 of 305, via a comparison of a logical address index). If the read command 185 is a sequential read command, the process 300 may proceed to 315, otherwise the process 300 may proceed to 325 (e.g., based on receiving a random read command).

At 315, the memory system 110 may determine whether an address of the read command 185 of 305 is associated with a sequential physical address (e.g., a continuous PPA). For example, the memory system 110 may determine (e.g., compare, identify, evaluate) whether a physical address associated with the read command 185 of 305 is sequential to one or more physical addresses associated with one or more other read commands 185 (e.g., previously-received read commands in a sequence of commands). If the read command 185 of 305 is associated with a physical address that is sequential to a physical address of one or more other read commands, the process 300 may proceed to 320, otherwise the process 300 may proceed to 325.

At 320, the memory system 110 may increment a value of a counter, which may monitor (e.g., store, track, indicate) a quantity of commands (e.g., subsequently received commands) that are associated with sequential physical addresses (e.g., a PPA continuous command count).

At 325, the memory system 110 may alternatively reset (e.g., set to zero, reset to an initial value) the value of the counter (e.g., based on a random read command 185 or a non-sequential physical address).

At 330, the memory system 110 may determine whether the value of the counter satisfies (e.g., is greater than or equal to) a threshold (e.g., a threshold quantity of sequential physical addresses, a threshold quantity of read commands having sequential physical addresses, 32 sequential PPAs). In some examples, the memory system 110 may configure (e.g., set, adjust) the threshold such that a given type of command is issued for a target degree of dirtiness (e.g., such that multi-plane read commands are issued between 1% and 5% degree of dirtiness). Accordingly, at a relatively low degree of dirtiness, the memory system 110 may use a multi-plane read command, and at a relatively high degree of dirtiness, the memory system 110 may use a single plane read command. In some examples, the threshold may be configured based on parameters (e.g., capacity, processing capability, or other characteristics) associated with one or more memory devices 130 of the memory system 110 (e.g., NAND parameters).

If the memory system 110 determines that value of the counter fails to satisfy the threshold (e.g., is less than the threshold, if a degree of randomness is greater than or equal to a threshold), the process 300 may proceed to 335. At 335 the memory system 110 may output a first type of read command 190 (e.g., a single-plane read command) to retrieve (e.g., sense) corresponding data from a memory device 130.

If the memory system 110 determines that the value of the counter satisfies the threshold (e.g., is greater than or equal to the threshold, if a degree of randomness is less than a threshold), the process 300 may proceed to 340. At 340, the memory system 110 may output a second type of read command 190 (e.g., a multi-plane read command) to retrieve corresponding data. Although, the process 300 shows processing of a single read command 185, the process 300 may support processing of multiple read commands 185.

Thus, by performing one or more techniques in accordance with the process 300, a memory system 110 may configure (e.g., generate, output) different types of read commands 190 to a memory device 130 based on a degree of randomness of host read commands 185. Such enhanced read command processing techniques may improve data throughput by utilizing, for example, relatively fewer multi-plane read commands, which may reduce idle durations of memory devices 130. Moreover, by utilizing an increased quantity of single-plane read commands, the memory system 110 may support increased processing speeds for sequential read commands (e.g., associated with dirty data) received from a host system 105, thus improving system performance under variable workload conditions.

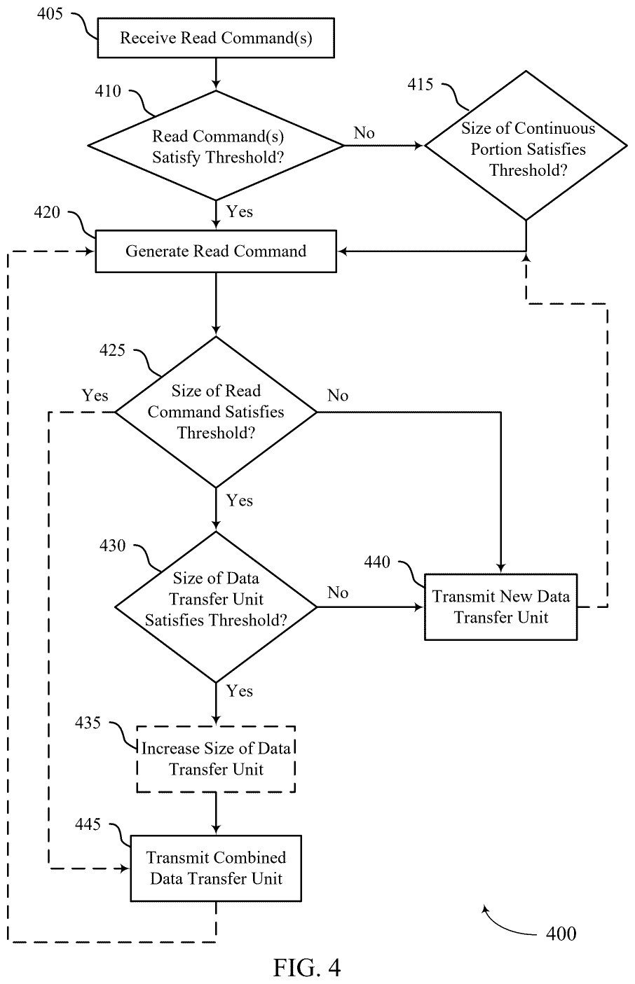

FIG. 4 shows an example of a process 400 that supports sequential and random read operations in memory systems in accordance with examples as disclosed herein. The process 400 may be implemented by aspects of a system 100 or a system 200. For example, a memory system 110 (e.g., a memory system controller 115) may utilize one or more aspects of the process 400 to improve read command processing techniques. For example, the process 400 may enable a memory system 110 to determine (e.g., select, adjust, allocate) a quantity of data transfer units 195 to transmit (e.g., output, issue, transfer) based on a size of a read command 190 and a size of a remaining size of a data transfer unit 195. Although the following description of the process 400 illustrates an example flow of operations, the operations may be performed in a different order. Additionally, or alternatively, other operations may be added to or removed from the process 400. For example, some operations may be omitted from the process 400, or may be performed in different orders or at different times.

A memory system 110 may be configured to communicate data with a host system 105 in response to receiving one or more read commands 185. Based on (e.g., after, in response to) receiving the one or more read commands 185, the memory system 110 may be configured generate a read command 190 and output the read command 190 to a memory device 130. Accordingly, the memory device 130 (e.g., a local controller 135) may retrieve the data corresponding to the one or more read commands 185 and may collect (e.g., store, accumulate) the data in one or more data transfer units 195 (e.g., a data transport container, a buffer, a DATA IN module). Subsequently, the memory system 110 may transmit the one or more data transfer units 195 data to the host system 105. However, in some cases, the memory system 110 may utilize one data transfer unit 195 per read command 185 regardless of a size associated with the read command 185 or a remaining size of the data transfer unit 195.

In accordance with techniques described herein, a memory system 110 (e.g., a memory system controller 115) may perform aspects of the process 400 to enhance efficiency of read command processing.

At 405, the memory system 110 may receive one or more read commands 185 (e.g., from a host system 105). The read command(s) 185 of 405 may be associated with a size (e.g., a “chunk” size).

At 410, in some examples, the memory system 110 may determine whether a size of the read command(s) 185 of 405 satisfy (e.g., is less than or equal to) a threshold (e.g., a first threshold quantity of bits, 16 KB). If the read command(s) 185 fail to satisfy the threshold, the process may proceed to 415, otherwise the process may proceed to 420 (e.g., if the continuous portion of the read command(s) 185 fails to satisfy the threshold).

At 415, in some examples, the memory system 110 may determine whether a size of a continuous portion (e.g., a continuous PPA size) of the read command(s) 185 of 405 satisfies (e.g., is less than or equal to) a threshold (e.g., a fourth threshold quantity of bits, 16 KB). In some examples, if the size of the continuous portions of the read command(s) 185 fails to satisfy the threshold, the process may proceed to 420. In some examples, if the size of the continuous portions of the read command(s) 185 satisfies the threshold, the memory system 110 may generate a single read command 190 (e.g., at 420), which may utilize (e.g., transmit) a single corresponding data transfer unit (e.g., at 440).

At 420, the memory system may generate a read command 190 (e.g., a single-plane read command, a multi-plane read command, a NAND read command) to access a set of memory cells of a memory device 130 of the memory system 110.

At 425, the memory system 110 may determine whether a size of the read command 190 satisfies (e.g., is less than or equal to) a threshold (e.g., a second threshold quantity of bits, 16 KB). If the size of the read command 190 satisfies the threshold, the process 400 may proceed to 430, otherwise the process 400 may proceed to 440. In some examples, if the size of the read command 190 satisfies the threshold, the process 400 may proceed directly to 445 (e.g., may transmit a combined data transfer unit 195 based on the size of the read command 190 failing to satisfy the threshold).

At 430, the memory system 110 may determine whether a size of a data transfer unit 195 (e.g., a current data transfer unit size, a pending data transfer unit size) satisfies a threshold (e.g., a third threshold quantity of bits, 16 KB). For example, one or more previously-processed read commands 190 may have filled at least a portion of a pending data transfer unit 195 and the memory system 110 may determine whether a remaining size of the data transfer unit 195 satisfies the threshold (e.g., whether the current data transfer unit has sufficient size to transfer of data associated with the read command 190 of 420). If the size (e.g., remaining size) of the data transfer unit 195 satisfies the threshold, the process 400 may proceed to 435 and, if not, the process 400 may proceed to 440.

At 435, in some examples, the memory system 110 may increase the size of the data transfer unit 195. That is, the memory system 110 may combine (e.g., allocate space for) first data associated with a first read command 190 and second data associated with one or more second read commands 190, and the data transfer unit 195 may include the first data and the second data.

At 445, the memory system 110 may transmit a data transfer unit 195 (e.g., a combined data transfer unit), which may include data associated with multiple read commands 190 (e.g., a current read command 190 and one or more previous read commands 190). Accordingly, a data transfer unit 195 may be configured with increased capacity for transferring data (e.g., to a host system).

At 440, the memory system 110 may alternatively transmit a new data transfer unit 195 to carry data associated with a read command 190. That is, if the size of the read command 190 fails to satisfy the threshold of 425 (e.g., is greater than, or greater than or equal to a threshold quantity of bits) or the size of the data transfer unit 195 fails to satisfy the threshold of 430 (e.g., is greater than, or greater than or equal to a threshold quantity of bits), a pending data transfer unit 195 may not have sufficient space to transfer additional data associated with subsequent read commands 190. Accordingly, the memory system 110 may transmit a current data transfer unit 195 (e.g., associated with one or more previous read commands 190) as well as a new data transfer unit 195 (e.g., associated with a current read command 190).

After transmitting the combined data transfer unit 195 or multiple data transfer units 195, the memory system 110 may conclude the process. However, in some examples, the memory system may continue to perform at least some aspects of the process 400 (e.g., as part of a loop). For example, after 440 or 445, the memory system 110 may return to 420 and may continue to generate subsequent read commands 190 and perform subsequent operations of the process 400. It may be noted that the various thresholds of the process 400 may be a same value or may be different values.

Thus, by performing one or more techniques in accordance with the process 400, a memory system 110 may merge data from multiple read commands 190 into a single data transfer unit 195. Such techniques may reduce processing overhead associated with transmitting data to a host system 105 by reducing a quantity of data transfer units 195 used to transfer data, which may improve performance of read command processing (e.g., improve random read command performance). Moreover, by utilizing relatively fewer data transfer units 195, the memory system 110 may use relatively fewer resources (e.g., command processing resources), which may result in relatively fewer idle planes 165 and increased system efficiency.

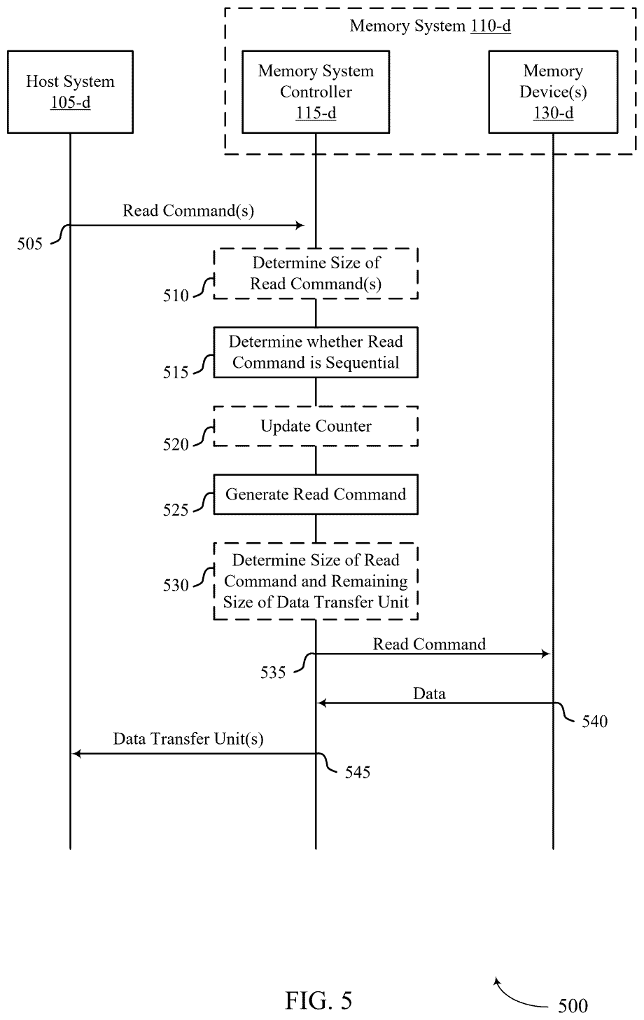

FIG. 5 shows an example of a process flow 500 that supports sequential and random read operations in memory systems in accordance with examples as disclosed herein. The process flow 500 may be implemented by aspects of a system 100 or a system 200, and may include aspects of the process 300, the process 400, or a combination thereof. For example, the process flow 500 may illustrate an example for operations of and signaling between a host system 105-d and a memory system 110-d, which may include a memory system controller 115-d and one or more memory devices 130-d. Aspects of the process flow 500 may be implemented by processing circuitry (e.g., of the host system 105-d, of the memory system controller 115-d, of the memory device(s) 130-d), such as one or more processors, one or more controllers, among other components. Additionally, or alternatively, aspects of the process flow 500 may be implemented as instructions (e.g., as software, as firmware) stored in one or more memories. For example, the instructions, when executed by processing circuitry (e.g., of the host system 105-d, of the memory system controller 115-d, of the memory device(s) 130-d), may cause the processing circuitry to perform the operations of the process flow 500.

In the process flow 500, operations of or signaling between the host system 105-d, the memory system controller 115-d, and the memory device(s) 130-d may be performed in a different order than the order shown, or other operations or signaling may be added or removed from the process flow 500. For example, some operations may omitted from the process flow 500, or may be performed in different orders or at different times. Although the host system 105-d, the memory system controller 115-d, and the memory device 130-d are shown performing particular operations or signaling in the process flow 500, any of the host system 105-d, the memory system controller 115-d, or the memory device 130-d may be configured to perform any of the techniques as described.

At 505, one or more read commands (e.g., read commands 185) may communicated. For example, the host system 105-d may transmit one or more first read commands (e.g., a sequence of read commands, continuous read commands, a chunk of host commands), which may be received by the memory system 110-d (e.g., by the memory system controller 115-d).

In some examples, at 510, a size of one or more read commands may be determined. For example, the memory system controller 115-d may determine whether a size of multiple read commands satisfies a threshold (e.g., is less than, or less than or equal to a threshold quantity of bits) based on receiving the one or more read commands of 505, among other read commands that may have been received before 505, in some examples. In some examples, the memory system controller 115-d may determine whether a size of a continuous portion of the one or more read commands satisfies a threshold (e.g., is less than, or less than or equal to a threshold quantity of continuous PPAs) based on determining that the size of the one or more read commands fails to satisfy a threshold.

At 515, a sequential read command or a non-sequential read command may be determined. For example, the memory system controller 115-d may determine whether a first physical address of a memory device 130-d associated with a first read command is sequential to one or more second physical addresses associated with one or more second read commands. In some examples, the memory system controller 115-d may identify whether a read command corresponds to a sequential read command or a random read command.

In some examples, at 520, a value of a counter may be updated. For example, the memory system controller 115-d may increment a value of a counter 275 based on (e.g., in response to, after) determining that a first physical address is sequential to the one or more second physical addresses. In some examples, the memory system controller 115-d may reset a value of a counter based on (e.g., in response to, after) determining that the first physical address is not sequential to the one or more second physical addresses.

At 525, a read command (e.g., a read command 190) may be generated. For example, the memory system controller 115-d may generate a first read command associated with accessing a set of memory cells of one or more memory devices 130-d.

In some examples, at 530, a size of the read command (e.g., the read command 190, the generated read command) and a remaining size of a data transfer unit may be determined. For example, the memory system controller 115-d may determine whether the size of the first read command satisfies a first threshold (e.g., is less than, or less than or equal to a first threshold quantity of bits) and whether a remaining size of a data transfer unit satisfies a second threshold (e.g., is less than, or less than or equal to a second threshold quantity of bits). In some examples, the memory system controller 115-d may generate the size of a read command at 525 based on the determination at 530.

At 535, a read command (e.g., a read command 190) may be output. For example, the memory system controller 115-d may output a first type of read command or a second type of read command to read a first physical address of one or more of the memory devices 130-d, and such a read command may be received by the memory device(s) 130-d. In some examples, the memory system controller 115-d may output a single-plane read command (e.g., associated with accessing a single plane of memory cells of a memory device 130-d) based on the value of the counter failing to satisfy the threshold or based on determining that the first physical address is not sequential to the one or more second physical addresses. In some other examples, the memory system controller 115-d may output a multi-plane read command (e.g., associated with accessing two or more planes of memory cells of a memory device 130-d) based on the value of the counter satisfying the threshold.

At 540, data may be received. For example, a memory device 130-d may transmit data in response to a read command of 535 (e.g., data corresponding to the read command), which may be received by the memory system controller 115-d.

At 545, one or more data transfer units (e.g., data transfer units 195) may be transmitted. For example, the memory system controller 115-d may transmit, to the host system 105-d, the data transfer unit, or the data transfer unit and a second data transfer unit, based on determining whether the size of the first read command satisfies the first threshold of 530 and whether the remaining size of the data transfer unit satisfies the second threshold of 530. In some examples, the memory system controller 115-d may transmit the data transfer unit (e.g., a combined data transfer unit including first data associated with a first read and second data associated with one or more second read commands) command based on determining that the size of the first read command satisfies the first threshold and that the remaining size of the data transfer unit satisfies the second threshold. Additionally, or alternatively, the memory system controller 115-d may transmit the data transfer (e.g., including second data associated with one or more second read commands) unit and the second data transfer unit (e.g., including first data associated with the first read command) based on determining that the size of the first read command fails to satisfy the first threshold or that the remaining size of the data transfer unit fails to satisfy the second threshold.

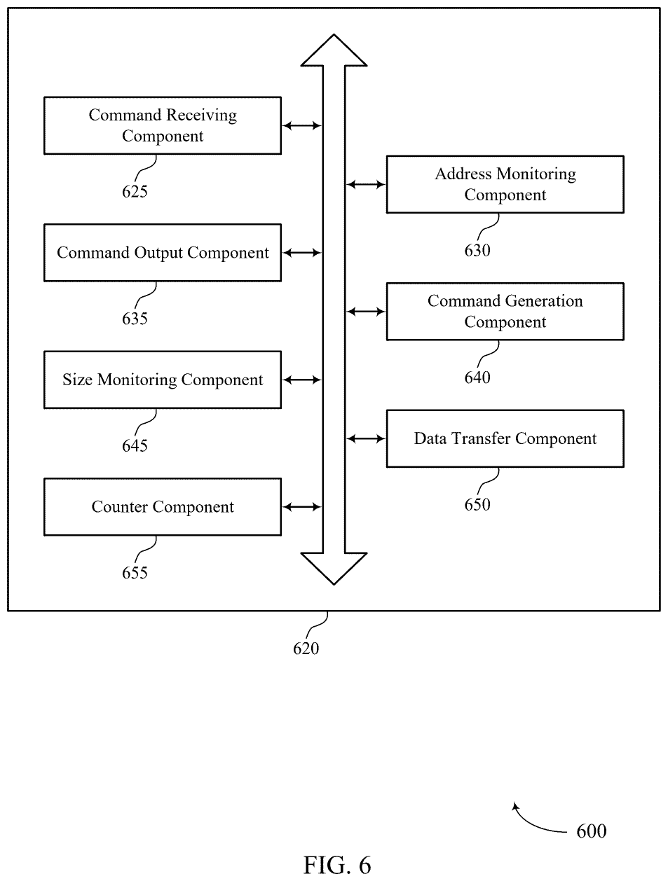

FIG. 6 shows a block diagram 600 of a memory system 620 that supports sequential and random read operations in memory systems in accordance with examples as disclosed herein. The memory system 620 may be an example of aspects of a memory system as described with reference to FIGS. 1 through 5. The memory system 620, or various components thereof, may be an example of means for performing various aspects of sequential and random read operations in memory systems as described herein. For example, the memory system 620 may include a command receiving component 625, an address monitoring component 630, a command output component 635, a command generation component 640, a size monitoring component 645, a data transfer component 650, a counter component 655, or any combination thereof. Each of these components, or components or subcomponents thereof (e.g., one or more processors, one or more memories), may communicate, directly or indirectly, with one another (e.g., via one or more buses).

In some examples, the command receiving component 625 may be configured as or otherwise support a means for receiving a first read command, the address monitoring component 630 may be configured as or otherwise support a means for determining whether a first physical address of a memory device of the one or more memory devices associated with the first read command is sequential to one or more second physical addresses associated with one or more second read commands, and the command output component 635 may be configured as or otherwise support a means for outputting (e.g., to a memory device) a first type of read command or a second type of read command to read the first physical address of the memory device based at least in part on whether the first physical address is sequential to the one or more second physical addresses.

In some examples, the counter component 655 may be configured as or otherwise support a means for incrementing a value of a counter based at least in part on determining that the first physical address is sequential to the one or more second physical addresses, and outputting the first type of read command or the second type of read command may be based at least in part on the value of the counter satisfying a threshold.

In some examples, the command output component 635 may be configured as or otherwise support a means for outputting the first type of read command based at least in part on the value of the counter failing to satisfy the threshold, and the first type of read command may include a single-plane read command associated with accessing a plane of memory cells of the memory device.

In some examples, the command output component 635 may be configured as or otherwise support a means for outputting the second type of read command based at least in part on the value of the counter satisfying the threshold, and the second type of read command may include a multi-plane read command associated with accessing two or more planes of memory cells of the memory device.

In some examples, the address monitoring component 630 may be configured as or otherwise support a means for identifying whether the first read command corresponds to a sequential read command or a random read command, and determining whether the first physical address is sequential to the one or more second physical addresses may be based at least in part on the identifying.

In some examples, the address monitoring component 630 may be configured as or otherwise support a means for determining that the first physical address is not sequential to the one or more second physical addresses. In some examples, the command output component 635 may be configured as or otherwise support a means for outputting the first type of read command based at least in part on determining that the first physical address is not sequential to the one or more second physical addresses.

In some examples, the counter component 655 may be configured as or otherwise support a means for resetting a value of a counter based at least in part on determining that the first physical address is not sequential to the one or more second physical addresses, and outputting the first type of read command may be based at least in part on resetting the value of the counter.

In some examples, to support receiving the first read command, the command receiving component 625 may be configured as or otherwise support a means for receiving a sequence of read commands including the one or more second read commands and the first read command, and the first read command may be continuous with the one or more second read commands in the sequence of read commands.

In some examples, command generation component 640 may be configured as or otherwise support a means for generating a first read command associated with accessing a set of memory cells of a memory device of the one or more memory devices, the size monitoring component 645 may be configured as or otherwise support a means for determining, based at least in part on generating the first read command, whether a size of the first read command satisfies a first threshold and whether a remaining size of a data transfer unit satisfies a second threshold, and the data transfer component 650 may be configured as or otherwise support a means for transmitting the data transfer unit, or the data transfer unit and a second data transfer unit, based at least in part on determining whether the size of the first read command satisfies the first threshold and whether the remaining size of the data transfer unit satisfies the second threshold.

In some examples, the data transfer component 650 may be configured as or otherwise support a means for transmitting the data transfer unit based at least in part on determining that the size of the first read command satisfies the first threshold and that the remaining size of the data transfer unit satisfies the second threshold.

In some examples, to support transmitting the data transfer unit, the data transfer component 650 may be configured as or otherwise support a means for combining first data associated with the first read command and second data associated with one or more second read commands, and the data transfer unit may include the first data and the second data based at least in part on the combining.

In some examples, the data transfer component 650 may be configured as or otherwise support a means for transmitting the data transfer unit and the second data transfer unit based at least in part on determining that the size of the first read command fails to satisfy the first threshold or that the remaining size of the data transfer unit fails to satisfy the second threshold, the data transfer unit including second data associated with one or more second read commands and the second data transfer unit includes first data associated with the first read command.

In some examples, the command receiving component 625 may be configured as or otherwise support a means for receiving a plurality of third read commands from a host system. In some examples, the size monitoring component 645 may be configured as or otherwise support a means for determining whether a size of the plurality of third read commands satisfies a third threshold based at least in part on receiving the plurality of third read commands, and generating the first read command may be based at least in part on determining whether the size of the plurality of third read commands satisfies the third threshold.

In some examples, the size monitoring component 645 may be configured as or otherwise support a means for determining whether a size of a continuous portion of the plurality of third read commands satisfies a fourth threshold based at least in part on determining that the size of the plurality of third read commands fails to satisfy the third threshold, and generating the first read command may be based at least in part on determining whether the size of the continuous portion satisfies the fourth threshold.

In some examples, to support transmitting the data transfer unit or the data transfer unit and the second data transfer unit, the data transfer component 650 may be configured as or otherwise support a means for transmitting the data transfer unit based at least in part on determining that the size of the first read command satisfies the first threshold and that the size of the plurality of third read commands satisfies the third threshold, the data transfer unit including first data associated with the first read command and second data associated with one or more second read commands.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

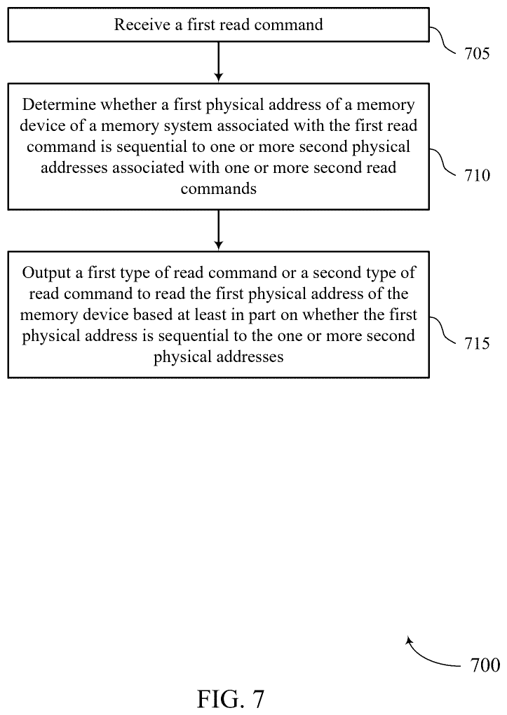

FIG. 7 shows a flowchart illustrating a method 700 that supports sequential and random read operations in memory systems in accordance with examples as disclosed herein. The operations of method 700 may be implemented by a memory system or its components as described herein (e.g., a memory system controller 115). For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include receiving a first read command. In some examples, aspects of the operations of 705 may be performed by a command receiving component 625 as described with reference to FIG. 6.

At 710, the method may include determining whether a first physical address of a memory device of a memory system associated with the first read command is sequential to one or more second physical addresses associated with one or more second read commands. In some examples, aspects of the operations of 710 may be performed by an address monitoring component 630 as described with reference to FIG. 6.

At 715, the method may include outputting a first type of read command or a second type of read command to read the first physical address of the memory device based at least in part on whether the first physical address is sequential to the one or more second physical addresses. In some examples, aspects of the operations of 715 may be performed by a command output component 635 as described with reference to FIG. 6.

In some examples, an apparatus as described herein may perform a method or methods, such as the method 700. The apparatus may include features, circuitry (e.g., processing circuitry), logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first read command; determining whether a first physical address of a memory device of the one or more memory devices associated with the first read command is sequential to one or more second physical addresses associated with one or more second read commands; and outputting a first type of read command or a second type of read command to read the first physical address of the memory device based at least in part on whether the first physical address is sequential to the one or more second physical addresses.

Aspect 2: The method, apparatus, or non-transitory computer-readable medium of aspect 1, further including operations, features, circuitry, logic, means, or instructions, or any combination thereof for incrementing a value of a counter based at least in part on determining that the first physical address is sequential to the one or more second physical addresses, where outputting the first type of read command or the second type of read command is based at least in part on the value of the counter satisfying a threshold.

Aspect 3: The method, apparatus, or non-transitory computer-readable medium of aspect 2, further including operations, features, circuitry, logic, means, or instructions, or any combination thereof for outputting the first type of read command based at least in part on the value of the counter failing to satisfy the threshold, where the first type of read command includes a single-plane read command associated with accessing a plane of memory cells of the memory device.

Aspect 4: The method, apparatus, or non-transitory computer-readable medium of aspect 2, further including operations, features, circuitry, logic, means, or instructions, or any combination thereof for outputting the second type of read command based at least in part on the value of the counter satisfying the threshold, where the second type of read command includes a multi-plane read command associated with accessing two or more planes of memory cells of the memory device.

Aspect 5: The method, apparatus, or non-transitory computer-readable medium of any of aspects 1 through 4, further including operations, features, circuitry, logic, means, or instructions, or any combination thereof for identifying whether the first read command corresponds to a sequential read command or a random read command, where determining whether the first physical address is sequential to the one or more second physical addresses is based at least in part on the identifying.

Aspect 6: The method, apparatus, or non-transitory computer-readable medium of aspect 1, further including operations, features, circuitry, logic, means, or instructions, or any combination thereof for determining that the first physical address is not sequential to the one or more second physical addresses and outputting the first type of read command based at least in part on determining that the first physical address is not sequential to the one or more second physical addresses.

Aspect 7: The method, apparatus, or non-transitory computer-readable medium of aspect 6, further including operations, features, circuitry, logic, means, or instructions, or any combination thereof for resetting a value of a counter based at least in part on determining that the first physical address is not sequential to the one or more second physical addresses, where outputting the first type of read command is based at least in part on resetting the value of the counter.

Aspect 8: The method, apparatus, or non-transitory computer-readable medium of any of aspects 1 through 7, where receiving the first read command includes operations, features, circuitry, logic, means, or instructions, or any combination thereof for receiving a sequence of read commands including the one or more second read commands and the first read command, where the first read command is continuous with the one or more second read commands in the sequence of read commands.

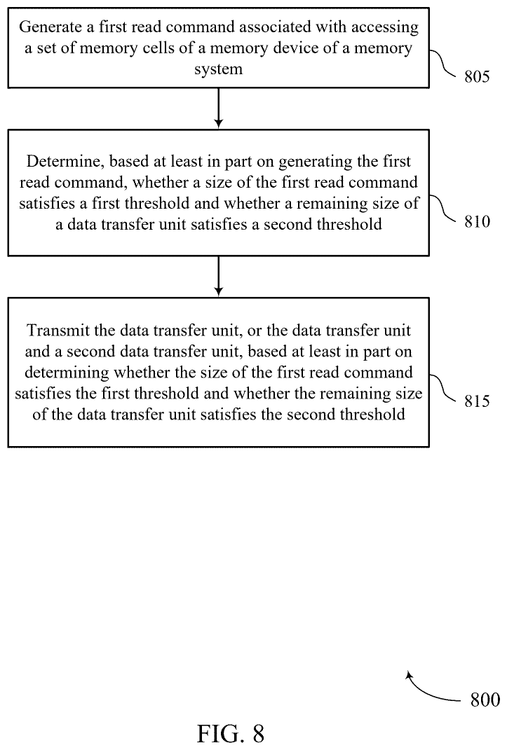

FIG. 8 shows a flowchart illustrating a method 800 that supports sequential and random read operations in memory systems in accordance with examples as disclosed herein. The operations of method 800 may be implemented by a memory system or its components as described herein (e.g., a memory system controller 115). For example, the operations of method 800 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 805, the method may include generating a first read command associated with accessing a set of memory cells of a memory device of one or more memory devices of a memory system. In some examples, aspects of the operations of 805 may be performed by a command generation component 640 as described with reference to FIG. 6.

At 810, the method may include determining, based at least in part on generating the first read command, whether a size of the first read command satisfies a first threshold and whether a remaining size of a data transfer unit satisfies a second threshold. In some examples, aspects of the operations of 810 may be performed by a size monitoring component 645 as described with reference to FIG. 6.

At 815, the method may include transmitting the data transfer unit, or the data transfer unit and a second data transfer unit, based at least in part on determining whether the size of the first read command satisfies the first threshold and whether the remaining size of the data transfer unit satisfies the second threshold. In some examples, aspects of the operations of 815 may be performed by a data transfer component 650 as described with reference to FIG. 6.

In some examples, an apparatus as described herein may perform a method or methods, such as the method 800. The apparatus may include features, circuitry (e.g., processing circuitry), logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for generating a first read command associated with accessing a set of memory cells of a memory device of the one or more memory devices; determining, based at least in part on generating the first read command, whether a size of the first read command satisfies a first threshold and whether a remaining size of a data transfer unit satisfies a second threshold; and transmitting the data transfer unit, or the data transfer unit and a second data transfer unit, based at least in part on determining whether the size of the first read command satisfies the first threshold and whether the remaining size of the data transfer unit satisfies the second threshold.

Aspect 10: The method, apparatus, or non-transitory computer-readable medium of aspect 9, where transmitting the data transfer unit or the data transfer unit and the second data transfer unit includes operations, features, circuitry, logic, means, or instructions, or any combination thereof for transmitting the data transfer unit based at least in part on determining that the size of the first read command satisfies the first threshold and that the remaining size of the data transfer unit satisfies the second threshold.

Aspect 11: The method, apparatus, or non-transitory computer-readable medium of aspect 10, where transmitting the data transfer unit includes operations, features, circuitry, logic, means, or instructions, or any combination thereof for combining first data associated with the first read command and second data associated with one or more second read commands, where the data transfer unit includes the first data and the second data based at least in part on the combining.

Aspect 12: The method, apparatus, or non-transitory computer-readable medium of aspect 9, where transmitting the data transfer unit or the data transfer unit and the second data transfer unit includes operations, features, circuitry, logic, means, or instructions, or any combination thereof for transmitting the data transfer unit and the second data transfer unit based at least in part on determining that the size of the first read command fails to satisfy the first threshold or that the remaining size of the data transfer unit fails to satisfy the second threshold, the data transfer unit including second data associated with one or more second read commands and the second data transfer unit includes first data associated with the first read command.

Aspect 13: The method, apparatus, or non-transitory computer-readable medium of any of aspects 9 through 12, further including operations, features, circuitry, logic, means, or instructions, or any combination thereof for receiving a plurality of third read commands from a host system and determining whether a size of the plurality of third read commands satisfies a third threshold based at least in part on receiving the plurality of third read commands, where generating the first read command is based at least in part on determining whether the size of the plurality of third read commands satisfies the third threshold.

Aspect 14: The method, apparatus, or non-transitory computer-readable medium of aspect 13, further including operations, features, circuitry, logic, means, or instructions, or any combination thereof for determining whether a size of a continuous portion of the plurality of third read commands satisfies a fourth threshold based at least in part on determining that the size of the plurality of third read commands fails to satisfy the third threshold, where generating the first read command is based at least in part on determining whether the size of the continuous portion satisfies the fourth threshold.

Aspect 15: The method, apparatus, or non-transitory computer-readable medium of aspect 13, where transmitting the data transfer unit or the data transfer unit and the second data transfer unit includes operations, features, circuitry, logic, means, or instructions, or any combination thereof for transmitting the data transfer unit based at least in part on determining that the size of the first read command satisfies the first threshold and that the size of the plurality of third read commands satisfies the third threshold, the data transfer unit including first data associated with the first read command and second data associated with one or more second read commands.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first read command;
determine whether a first physical address of a memory device of the one or more memory devices associated with the first read command is sequential to one or more second physical addresses associated with one or more second read commands; and
output a first type of read command or a second type of read command to read the first physical address of the memory device based at least in part on whether the first physical address is sequential to the one or more second physical addresses.

2. The memory system of claim 1, wherein the processing circuitry is further configured to cause the memory system to:
increment a value of a counter based at least in part on determining that the first physical address is sequential to the one or more second physical addresses, wherein outputting the first type of read command or the second type of read command is based at least in part on the value of the counter satisfying a threshold.

3. The memory system of claim 2, wherein the processing circuitry is further configured to cause the memory system to:
output the first type of read command based at least in part on the value of the counter failing to satisfy the threshold, wherein the first type of read command comprises a single-plane read command associated with accessing a plane of memory cells of the memory device.

4. The memory system of claim 2, wherein the processing circuitry is further configured to cause the memory system to:
output the second type of read command based at least in part on the value of the counter satisfying the threshold, wherein the second type of read command comprises a multi-plane read command associated with accessing two or more planes of memory cells of the memory device.

5. The memory system of claim 1, wherein the processing circuitry is further configured to cause the memory system to:
identify whether the first read command corresponds to a sequential read command or a random read command, wherein determining whether the first physical address is sequential to the one or more second physical addresses is based at least in part on the identifying.

6. The memory system of claim 1, wherein the processing circuitry is further configured to cause the memory system to:
determine that the first physical address is not sequential to the one or more second physical addresses; and
output the first type of read command based at least in part on determining that the first physical address is not sequential to the one or more second physical addresses.

7. The memory system of claim 6, wherein the processing circuitry is further configured to cause the memory system to:
reset a value of a counter based at least in part on determining that the first physical address is not sequential to the one or more second physical addresses, wherein outputting the first type of read command is based at least in part on resetting the value of the counter.

8. The memory system of claim 1, wherein the processing circuitry is configured to cause the memory system to:
receive a sequence of read commands comprising the one or more second read commands and the first read command, wherein the first read command is continuous with the one or more second read commands in the sequence of read commands.

9. A memory system, comprising:
one or more memory devices; and
processing circuitry coupled with the one or more memory devices and configured to cause the memory system to:
generate a first read command associated with accessing a set of memory cells of a memory device of the one or more memory devices;
determine, based at least in part on generating the first read command, whether a size of the first read command satisfies a first threshold and whether a remaining size of a data transfer unit satisfies a second threshold; and
transmit the data transfer unit, or the data transfer unit and a second data transfer unit, based at least in part on determining whether the size of the first read command satisfies the first threshold and whether the remaining size of the data transfer unit satisfies the second threshold.

10. The memory system of claim 9, wherein the processing circuitry is further configured to cause the memory system to:
transmit the data transfer unit based at least in part on determining that the size of the first read command satisfies the first threshold and that the remaining size of the data transfer unit satisfies the second threshold.

11. The memory system of claim 10, wherein, to transmit the data transfer unit, the processing circuitry is configured to cause the memory system to:
combine first data associated with the first read command and second data associated with one or more second read commands, wherein the data transfer unit includes the first data and the second data based at least in part on the combining.

12. The memory system of claim 9, wherein the processing circuitry is further configured to cause the memory system to:
transmit the data transfer unit and the second data transfer unit based at least in part on determining that the size of the first read command fails to satisfy the first threshold or that the remaining size of the data transfer unit fails to satisfy the second threshold, the data transfer unit including second data associated with one or more second read commands and the second data transfer unit includes first data associated with the first read command.

13. The memory system of claim 9, wherein the processing circuitry is further configured to cause the memory system to:
receive a plurality of third read commands from a host system; and
determine whether a size of the plurality of third read commands satisfies a third threshold based at least in part on receiving the plurality of third read commands, wherein generating the first read command is based at least in part on determining whether the size of the plurality of third read commands satisfies the third threshold.

14. The memory system of claim 13, wherein the processing circuitry is further configured to cause the memory system to:
determine whether a size of a continuous portion of the plurality of third read commands satisfies a fourth threshold based at least in part on determining that the size of the plurality of third read commands fails to satisfy the third threshold, wherein generating the first read command is based at least in part on determining whether the size of the continuous portion satisfies the fourth threshold.

15. The memory system of claim 13, wherein the processing circuitry is further configured to cause the memory system to:
transmit the data transfer unit based at least in part on determining that the size of the first read command satisfies the first threshold and that the size of the plurality of third read commands satisfies the third threshold, the data transfer unit including first data associated with the first read command and second data associated with one or more second read commands.

16. A non-transitory computer-readable medium storing code comprising instructions which, when executed by one or more processors of a memory system, cause the memory system to:
receive a first read command;
determine whether a first physical address of a memory device of the memory system associated with the first read command is sequential to one or more second physical addresses associated with one or more second read commands; and
output a first type of read command or a second type of read command to read the first physical address of the memory device based at least in part on whether the first physical address is sequential to the one or more second physical addresses.

17. The non-transitory computer-readable medium of claim 16, wherein the instructions, when executed by the one or more processors of the memory system, further cause the memory system to:
increment a value of a counter based at least in part on determining that the first physical address is sequential to the one or more second physical addresses, wherein outputting the first type of read command or the second type of read command is based at least in part on the value of the counter satisfying a threshold.

18. The non-transitory computer-readable medium of claim 17, wherein the instructions, when executed by the one or more processors of the memory system, further cause the memory system to:
output the first type of read command based at least in part on the value of the counter failing to satisfy the threshold, wherein the first type of read command comprises a single-plane read command associated with accessing a plane of memory cells of the memory device.

19. The non-transitory computer-readable medium of claim 17, wherein the instructions, when executed by the one or more processors of the memory system, further cause the memory system to:
output the second type of read command based at least in part on the value of the counter satisfying the threshold, wherein the second type of read command comprises a multi-plane read command associated with accessing two or more planes of memory cells of the memory device.

20. The non-transitory computer-readable medium of claim 16, wherein the instructions, when executed by the one or more processors of the memory system, further cause the memory system to:
identify whether the first read command corresponds to a sequential read command or a random read command, wherein determining whether the first physical address is sequential to the one or more second physical addresses is based at least in part on the identifying.

21. The non-transitory computer-readable medium of claim 16, wherein the instructions, when executed by the one or more processors of the memory system, further cause the memory system to:
determine that the first physical address is not sequential to the one or more second physical addresses; and
output the first type of read command based at least in part on determining that the first physical address is not sequential to the one or more second physical addresses.

22. The non-transitory computer-readable medium of claim 21, wherein the instructions, when executed by the one or more processors of the memory system, further cause the memory system to:
reset a value of a counter based at least in part on determining that the first physical address is not sequential to the one or more second physical addresses, wherein outputting the first type of read command is based at least in part on resetting the value of the counter.

23. A non-transitory computer-readable medium storing code comprising instructions which, when executed by one or more processors of a memory system, cause the memory system to:
generate a first read command associated with accessing a set of memory cells of a memory device of the memory system;
determine, based at least in part on generating the first read command, whether a size of the first read command satisfies a first threshold and whether a remaining size of a data transfer unit satisfies a second threshold; and
transmit the data transfer unit, or the data transfer unit and a second data transfer unit, based at least in part on determining whether the size of the first read command satisfies the first threshold and whether the remaining size of the data transfer unit satisfies the second threshold.

24. The non-transitory computer-readable medium of claim 23, wherein the instructions, when executed by the one or more processors of the memory system, cause the memory system to:
transmit the data transfer unit based at least in part on determining that the size of the first read command satisfies the first threshold and that the remaining size of the data transfer unit satisfies the second threshold.

25. The non-transitory computer-readable medium of claim 23, wherein the instructions, when executed by the one or more processors of the memory system, cause the memory system to:
transmit the data transfer unit and the second data transfer unit based at least in part on determining that the size of the first read command fails to satisfy the first threshold or that the remaining size of the data transfer unit fails to satisfy the second threshold, the data transfer unit including second data associated with one or more second read commands and the second data transfer unit includes first data associated with the first read command.
